(19) United States
(12) Patent Application Publication
(10) Pub. No.: US 2009/0027823 A1
(43) Pub. Date: Jan. 29, 2009

(54) Electromagnetic actuator with at least two windings

(75) Inventors: Stephane Follic, Crolles (FR); Michel Lauraire, Saint Maur Des Fosses (FR)

Correspondence Address: STEPTOE & JOHNSON LLP, 1330 CONNECTICUT AVENUE, N.W., WASHINGTON, DC, 20036, US

(73) Assignee: Schneider Electric Industries SAS, Rueil Malmaison (FR)

(21) Appl. No.: 12/213,731

(22) Filed: Jun. 24, 2008

(30) Foreign Application Priority Data
Jul. 23, 2007 (FR) 07 05343

(51) Int. Cl. H01H 47/32

(52) U.S. Cl. 361/153; 361/154

(57) ABSTRACT

An electromagnetic actuator comprises a yoke, a core, at least two windings and switching means of the windings from a series position to a parallel position and vice-versa. It comprises control means comprising regulating means of the electric current flowing in the windings. The control means comprise inrush means controlling the voltage supplied to the windings during a closing operation, and controlling the switching means to place the windings in parallel mode. The control means also comprise holding means controlling the current supplied to the windings during a holding operation of the actuator in the closed position and controlling the switching means to place the windings in series mode.

### BACKGROUND OF THE INVENTION

The invention relates to an electromagnetic actuator comprising a magnetic circuit formed by a ferromagnetic yoke extending along a longitudinal axis, and by a ferromagnetic movable core mounted with axial sliding along the longitudinal axis of the yoke. The actuator comprises at least two windings and means for switching the windings from a series position to a parallel position and vice-versa.

### STATE OF THE PRIOR ART

It is known to use at least two different types of windings for the inrush and holding phases of an electromagnetic actuator. Optimization of power operation of electromagnetic actuators is in fact often taken into account in their design stage. A known principle consists in using a first type of winding for the inrush phase and a second winding for the holding phase. The use of several specific windings is described in the state of the technique in particular in the following patents FR2290009, U.S. Pat. No. 4,227,231, U.S. Pat. No. 4,609,965, EP1009003. In general, the winding used for the inrush phase is dimensioned to withstand the essential part of the inrush power and the winding used for the holding phase is designed to supply the only ampere-turns necessary to hold the core in the closed position. Each of the windings is brought into operation according to the position of the core.

Furthermore, the need to use electromagnetic actuators with wide supply voltage ranges is also becoming a priority. Several solutions described in the following documents FR2568715, EP1009003, EP1009004 use means for regulating the supply voltage of the winding or windings. The voltage supplied to the windings is traditionally modulated in pulse width modulation PWM.

The use of pulsed currents as described in the document of the state of the art EP0998623 does not enable regulation of the electric current in the coil or coils to be obtained and enable said current to be maintained in accordance with a setpoint. Moreover, the use of pulsed currents does not enable a satisfactory level of regulation to be achieved. The use of pulsed current does in fact imply a fixed duty cycle, and not a duty cycle modulated according to the voltage. The current is therefore either directly a function of the voltage or linked to the voltage by a fixed ratio. There is therefore no decoupling between voltage and current. Independence between control voltage and current is not possible. Furthermore, a detrimental influence of the increase of the resistance value of the coil versus temperature is observed. Designing an electromagnetic actuator with operation which is both optimal in terms of electrical consumption and in terms of operating voltage range remains very difficult. The progress made in one of the two development directions is generally made to the detriment of the other. Moreover, operation of electromagnetic actuators during the drop-out or opening phase is generally not optimized.

### SUMMARY OF THE INVENTION

The object of the invention is therefore to remedy the shortcomings of the state of the art so as to propose an electromagnetic actuator with a high power efficiency.

The electromagnetic actuator according to the invention comprises control means comprising means for regulating the electric current flowing in said at least two windings, inrush means arranged such as to control the voltage supplied to said at least two windings during a closing operation of the actuator, and to control the switching means to place said at least two windings in parallel mode to generate a first inrush magnetic flux to close the actuator. The control means comprise holding means arranged such as to control the current supplied to said at least two windings during a holding operation of the actuator in the closed position and to control the switching means to place said at least two windings in series mode to generate a second holding magnetic flux.

According to a preferred embodiment, the regulating means comprise a comparator comparing the value of an electric current flowing in said at least two windings with a setpoint, said comparator being connected to a corrector associated with an amplifier controlling a switch.

Advantageously, the regulating means comprise control means to modulate the supply voltage of said at least two windings in pulse width modulation PWM.

Advantageously, the electromagnetic actuator comprises a first and a second windings.

According to a development of the invention, the switching means comprise a first opening means connected in series between a first terminal of the first winding and a first voltage supply terminal, a second terminal of the first winding being connected to a second voltage supply terminal via the control transistor. The switching means comprise a second opening means connected in series between the second terminal of the first winding and a second terminal of the second winding, said second winding having a first terminal connected to the first voltage supply terminal and the second terminal connected to the second voltage supply terminal via the control transistor. A third opening means is directly connected in series between the second terminal of the second winding and the first terminal of the second winding. At least one free-wheel diode is reverse-connected in parallel between the second terminal of the first winding and the first terminal of the second winding. The three opening means are arranged to receive orders from the inrush or holding means so as to respectively place the two windings in an open or closed state, the windings being in serial mode when the first and second opening means are open and the third opening means is closed, the windings being in parallel mode when the first and second opening means are closed and the third opening means is open.

The control means preferably comprise measuring means designed to detect the current flowing through the two windings.

According to a development of the invention, the control means comprise drop-out means arranged such as to control a counter-voltage supplied to the two windings, and to control the switching means to place the two windings in parallel mode to generate a third drop-out magnetic flux to open the actuator.

The drop-out means preferably comprise a fourth opening means connected in series with the free-wheel diode, a Zener diode reverse-connected in parallel to the terminals of the free-wheel diode, the fourth opening means being arranged to be controlled by the control sub-unit so as to switch to an open state and disconnect the free-wheel diode, a counter-voltage being applied to the terminals of the windings.

The control means preferably comprise voltage measuring means able to detect the voltage between the first and second voltage supply terminal before the closing operation and to control the voltage supplied to the windings according to the supply voltage detected during the closing operation.

The electromagnetic actuator preferably comprises a first and second winding having the same ohmic resistance.

The windings are preferably identical and comprise the same inductance and the same number of turns.

Advantageously, the windings are arranged on two separate coils.

Advantageously, the windings are cylindrical and aligned along the same longitudinal axis.

In a particular embodiment, the electromagnetic actuator comprises test means cyclically commanding change of configuration of said at least two windings during the holding phase, the test means sending orders to the switching means to temporarily place said at least two windings in parallel.

### BRIEF DESCRIPTION OF THE DRAWINGS

Other advantages and features will become more clearly apparent from the following description of particular embodiments of the invention, given as non-restrictive examples only, and represented in the accompanying drawings in which:

FIG. 1 represents a wiring diagram of an electromagnetic actuator with at least two windings according to a first preferred embodiment of the invention;

FIG. 2 represents a wiring diagram of an electromagnetic actuator with at least two windings according to a second preferred embodiment of the invention;

FIG. 3 represents a wiring diagram of an alternative embodiment of the switching means of an electromagnetic actuator according to the first preferred embodiment of FIG. 1;

FIG. 4 represents a wiring diagram of an alternative embodiment of the switching means of an electromagnetic actuator according to the embodiments of FIGS. 1 and 2;

FIG. 5 represents curves plotting the ratio of the maximum and minimum supply voltages versus the ratio of the inrush and holding currents;

FIG. 6 represents a perspective view of a particular embodiment of an actuator according to the embodiments of FIGS. 1 and 2;

FIG. 7A represents plots representative of the current in a winding in inrush phase versus the supply voltage, according to a known embodiment;

FIG. 7B represents plots representative of the current in a winding in inrush phase versus the supply voltage, according to an embodiment of the invention.

### DETAILED DESCRIPTION OF AN EMBODIMENT

According to a first mode preferred embodiment, the electromagnetic actuator comprises a fixed magnetic circuit made of ferromagnetic material. The magnetic circuit comprises a ferromagnetic yoke 2 extending along a longitudinal axis Y. A movable ferromagnetic core 3 is placed facing the yoke. Said core is mounted with axial sliding along the longitudinal axis Y of the yoke. The electromagnetic actuator comprises at least two windings L1, L2. Said at least two windings preferably extend along the longitudinal axis Y.

For example purposes as represented in FIG. 6, the actuator is of E type. Other geometries of actuators with a plunger core such as U-type actuators can be envisaged. The actuators can comprise or not comprise polar shoes or permanent magnets.

According to a preferred embodiment of the invention, the actuator comprises a first and second winding L1, L2. Switching means 10 place said at least two windings L1, L2 in series or in parallel according to the operating phase of the actuator.

Said at least two windings L1, L2 are connected in parallel during an inrush phase during which the actuator closes. During an actuator closing operation, said at least two windings L1, L2 generate a first inrush magnetic flux φᵢₙᵣᵤₛₕ to move movable core 3 from a first position P1 to a second position P2.

Said at least two windings are connected in series during a holding phase during which the actuator is kept in a closed position. Said at least two windings L1, L2 generate a second holding magnetic flux φ_{holding} to keep the movable core 16 in its second position P2.

Control means 20 control the switching means 10 to place said at least two windings L1, L2 in parallel mode or in series mode.

Control means 20 comprise regulating means 22 of the electric current flowing in said at least two windings L1, L2.

In inrush and/or holding phase, control means 20 regulate the electric current I flowing in the two windings L1, L2 of the actuator. This time-based regulation is preferably dependent on a setpoint which may be a function of several parameters taken either alone or in combination.

The setpoint can be set according to a current profile defined according to its evolution with time.

The setpoint can be set according to a time constant. A sudden transition between inrush and holding phase is then observed after a preset time.

The setpoint can be set according to the position of the movable armature. A sudden transition between inrush and holding phase is then observed when the movable armature of the actuator has reached a set position.

The setpoint can further be set as a function of the required closing time. This closing time is dependent on the source power on inrush. This constraint can then have an impact on consumption in holding phase. Limiting the consumption in holding phase enables the heat dissipation to be limited.

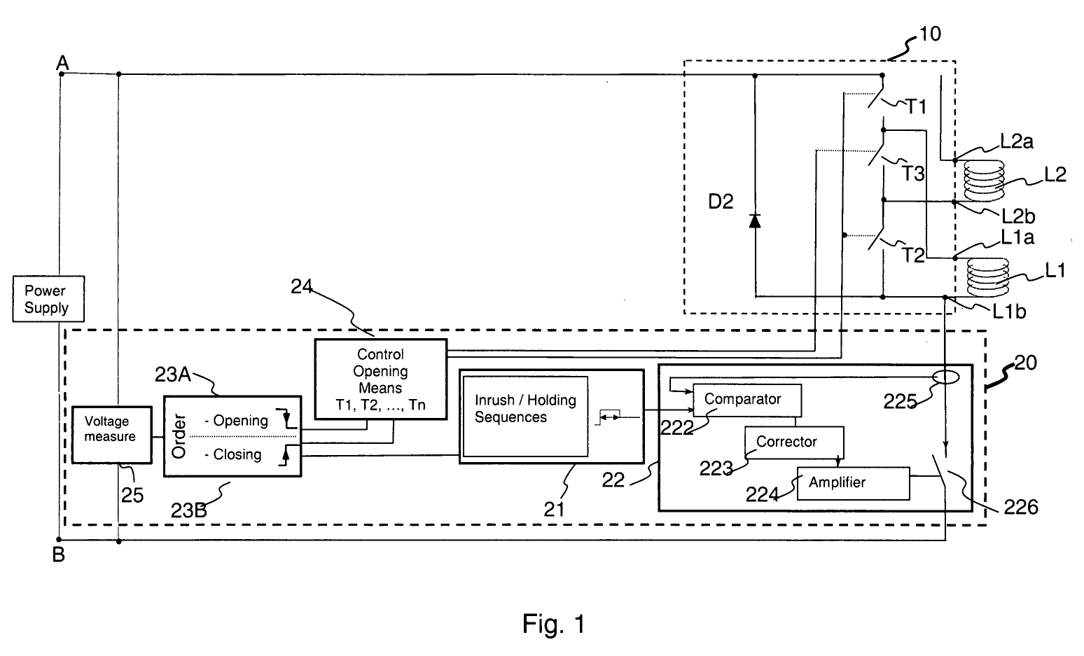

As represented in FIG. 1, this regulation is performed by a corrector 223 which can for example be a PID (Proportional Integral Derivative) controller. The PID controller is a control device enabling closed-loop regulation of the actuator to be performed, the regulation having to operate even if the environmental conditions change, in particular in case of change of the actuator supply voltage. The controller is associated with an amplifier 224 which can for example be a Pulse Width Modulation (PWM) type amplifier. The amplifier controls a switch 226. This pulse width modulation according to the voltage enables the current value to be adjusted as close as possible to the setpoint. The actual current flowing in said at least two windings L1, L2 is measured by a current sensor 225. A comparator 222 compares the value of said actual current with the setpoint. Current sensor 225 can for example be a measuring shunt such as a resistor R1 connected in series with said at least two windings L1, L2. The resistor has a known resistance value which is preferably weak.

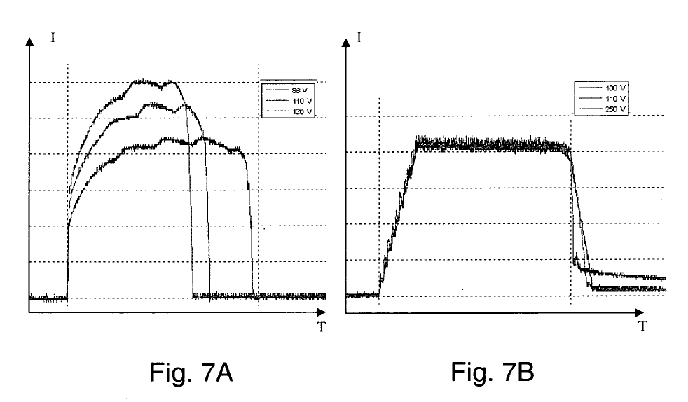

At each operating cycle (closing/holding), regulating means 22 enable a stable electric current to be supplied in reproducible manner. As represented in FIG. 7B, the electric current is then independent from the voltage and from temperature variations. An actuator is then obtained operating in a wide voltage range with a regulated currents window that is as wide as possible. Furthermore operation takes place in a manner that is relatively insensitive to the conditions of use. The only limitations concern the limits proper of PWM type regulation. Regulation is in fact limited within a certain voltage range between a minimum value and a maximum value.

The double-winding principle enables the voltage range or the ratio between the inrush current and holding current to be increased. These quantities are in fact linked by the coil resistance which is modified according to the operating phase (inrush or holding).

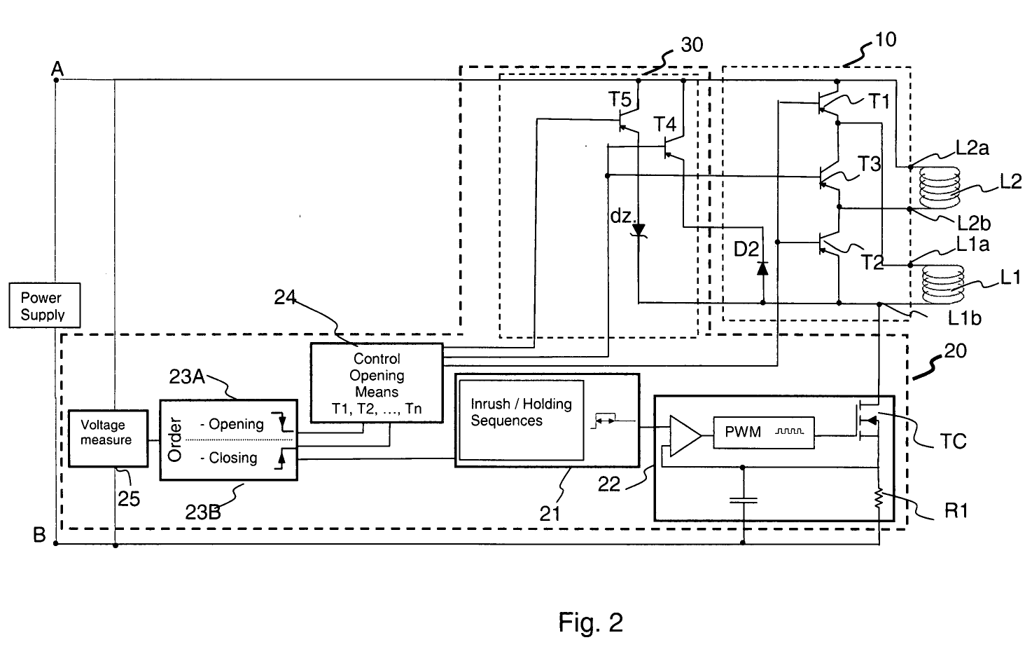

As an example embodiment, as represented in FIG. 2, regulating means 22 comprise a control transistor TC to modulate the voltage supplied to said at least two windings L1, L2 in pulse width modulation PWM. Coil current measurement is performed via resistor R1 associated with a filtering capacitor. The measurement is the compared with a comparator to modulate the PWM and enable current regulation to be obtained.

Control means 20 comprise inrush means 23B, 24, 21, 22 arranged such as to control the voltage supplied to said at least two windings L1, L2 during a closing operation of the actuator.

Control means 20 comprise holding means 23B, 24, 21, 22 arranged such as to control the electric current supplied to said at least two windings L1, L2 during a holding operation of the actuator in the closed position.

According to a first preferred embodiment of the invention represented in FIG. 1, switching means 10 comprise first opening means T1 connected in series between a first terminal L1a of first winding L1 and a first voltage supply terminal A. A second terminal L1b of first winding L1 is connected to a second voltage supply terminal B via a control transistor TC of regulating means 22.

Switching means 10 comprise second opening means T2 connected in series between second terminal L1b of first winding L1 and a second terminal L2b of second winding L2. Said second winding L2 has a first terminal L2a connected to first voltage supply terminal A and second terminal L2b connected to second voltage supply terminal B via control transistor TC.

A third opening means T3 is directly connected in series between second terminal L2b of second winding L2 and first terminal L1a of second winding L2.

As represented in FIGS. 1 and 2, at least one free-wheel diode D2 is reverse-connected in parallel between second terminal L1b of first winding L1 and first terminal L2a of second winding L2. Diode D2 is therefore not conducting when first voltage supply terminal A is supplied with a positive voltage.

The three opening means T1, T2, T3 are arranged to receive orders from a control sub-unit 24 so as to place themselves respectively in an open state and a closed state and vice-versa. Windings L1, L2 are in series mode when first and second opening means T1, T2 are open and third opening means T3 is closed. Windings L1, L2 are in parallel mode when first and second opening means T1, T2 are closed and third opening means T3 is open.

First and second opening means T1, T2 preferably respectively comprise a transistor able to be controlled by control sub-unit 24 of control means 20. Third opening means T3 further preferably comprise a transistor controlled by control sub-unit 24.

Control means 20 comprise measuring means R1 designed to detect the current flowing through the two windings L1, L2. Measuring means R1 comprise a current measuring resistor connected in series between control transistor TC and second voltage supply terminal B.

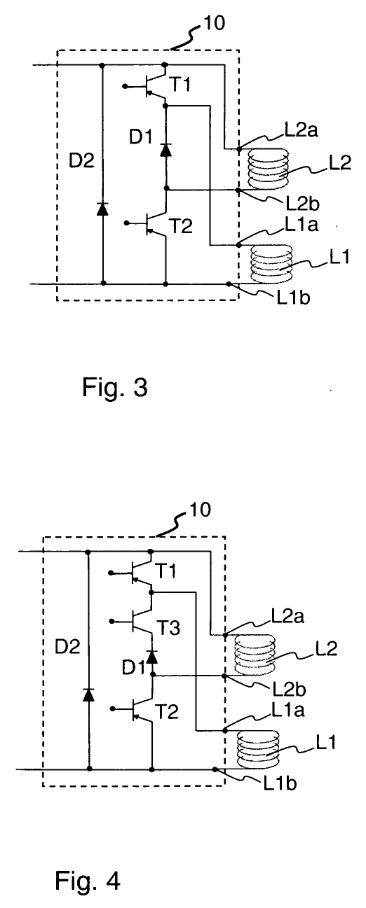

According to an alternative embodiment of the first preferred embodiment as represented in FIG. 3, third opening means T3 comprise a switching diode D1 reverse-connected in parallel to second winding L2. Adding switching diode D1 guarantees satisfactory operation if actuation of first and second opening means T1, T2 is not synchronized.

According to a particular embodiment of the first preferred embodiment, the electromagnetic actuator comprises a first and second coil L1, L2. The two coils L1, L2 have identical windings, and therefore substantially identical ohmic resistances, the same number of turns and the same inductance. Coils L1, L2 are preferably cylindrical and aligned along the same longitudinal axis Y.

By means of this configuration, the antagonistic stresses encountered in inrush phase and in holding phase can be dissociated. Moreover, the actuator according to the invention can be used for a wide supply voltage range which makes it very versatile.

The minimum and maximum resistances of the winding or windings used fix the width of the supply voltage range Uₘₐₓ/Uₘᵢₙ according to the inrush and holding current and the regulation control duty cycles. In a traditional configuration where a single winding is used with current regulation on inrush and holding, the ratio between the maximum service voltage and the minimum voltage is defined as follows:

Uₘₐₓ/Uₘᵢₙ=(τₘₐₓ×Rcoilₘᵢₙ)/(τₘᵢₙ×Rcoilₘₐₓ)×1/(Iᵢₙᵣᵤₛₕ/I_{holding})

where τₘₐₓᵢ corresponds to the maximum duty cycle equal to the ratio between the maximum pulse duration and the pulse send period and τₘᵢₙ corresponds to the minimum duty cycle equal to the ratio between the minimum pulse duration and the pulse send period. Rcoilₘₐₓ is equal to the maximum resistance of the winding in inrush phase and Rcoilₘᵢₙ is equal to the minimum resistance of the winding in holding phase.

In a traditional configuration, the variation of the winding resistance then depends essentially on the temperature.

According to the invention, the ratio between the maximum service voltage and the minimum voltage is defined as follows:

Uₘₐₓ/Uₘᵢₙ=k×(τₘₐₓ×Rcoilₘᵢₙ)/(τₘᵢₙ×Rcoilₘₐₓ)×1/(Iᵢₙᵣᵤₛₕ/I_{holding})

As the maximum and minimum resistances of the windings on inrush and on holding are adjustable and no longer depend solely on the temperature, the ratio between the maximum service voltage and the minimum voltage Uₘₐₓ/Uₘᵢₙ can be multiplied by a factor k. For example, if the resistances of the two windings L1, L2 are identical, switching between series mode and parallel mode enables a factor k equal to 4 to be obtained. The width of the supply voltage range and/or the inrush/holding current ratio can then be increased according to requirements, thus releasing the stress on the impedance seen by the control circuit.

According to a development of the invention, the maximum inrush current is determined according to a minimum voltage value Uₘᵢₙ of the voltage range for a maximum operating temperature and at maximum duty cycle. The maximum inrush current is expressed according to the following equation:

Iᵢₙᵣᵤₛₕ=Uₘᵢₙ×(τₘₐₓ)Rcoilₘₐₓ

where Rcoilₘₐₓ is equal to the resistance of the winding at a maximum operating temperature, and Uₘᵢₙ is equal to the minimum voltage of the operating range.

Furthermore, the minimum holding current is determined according to a maximum voltage value Uₘₐₓ of the voltage range, for a minimum operating temperature and at maximum duty cycle. The minimum holding current is expressed according to the following equation:

I_{holding}=Uₘₐₓ×(τₘₐₓ)×Rcoilₘᵢₙ

where Rcoilₘᵢₙ is equal to the resistance of the winding at a minimum operating temperature, and Uₘₐₓ is equal to the maximum voltage of the operating range.

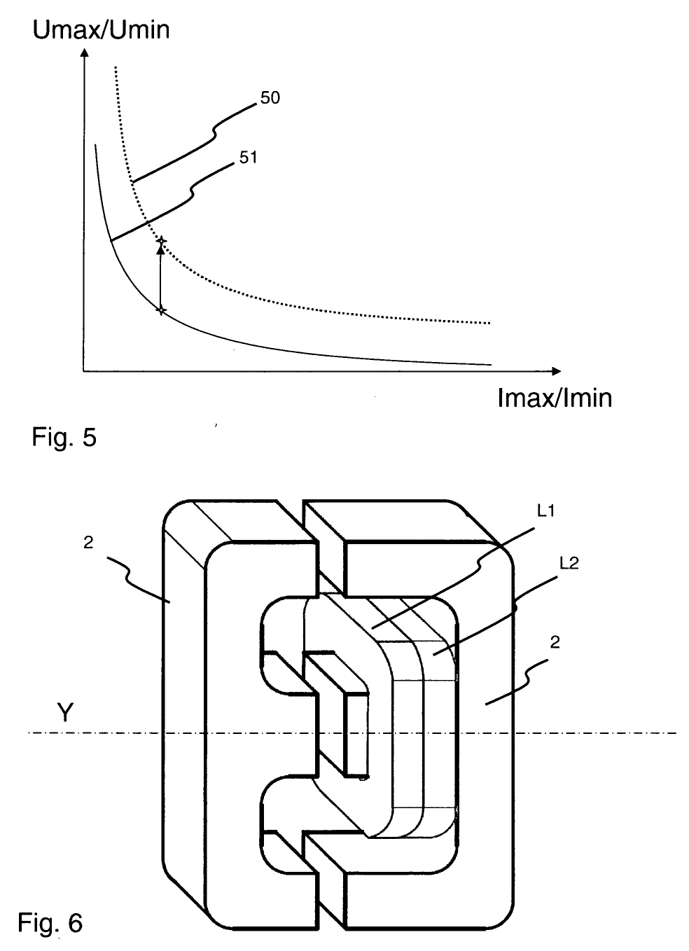

Dashed line plot 50 of FIG. 5 represents the ratio of the voltages Uₘₐₓ/Uₘᵢₙ versus the ratio of the inrush and holding currents Iᵢₙᵣᵤₛₕ/I_{holding} when the impedance of the windings varies between inrush phase and holding phase. Solid line plot 51 represents the ratio of the voltages Uₘₐₓ/Uₘᵢₙ versus the ratio of the inrush and holding currents Iᵢₙᵣᵤₛₕ/I_{holding} when the impedance of the windings does not vary.

As represented in FIG. 5, either the width of the voltage range Uₘₐₓ/Uₘᵢₙ and/or the ratio between the inrush and holding current Iᵢₙᵣᵤₛₕ/I_{holding} can therefore be increased. To obtain a maximum voltage range Uₘₐₓ/Uₘᵢₙ and a larger Iᵢₙᵣᵤₛₕ/I_{holding} current ratio, it is desirable to have a winding having the lowest resistance on inrush and the highest resistance on holding. According to a particular embodiment, the resistance can easily be multiplied by 4 (K=4) between inrush and holding.

According to a second preferred embodiment presented in FIG. 2, electromagnetic actuator control means 20 comprise drop-out means 23A, 24. Drop-out means 23A, 24 are arranged in such a way as to control a counter-voltage supplied to the two windings L1, L2 and to control switching means 10 to place the two windings L1, L2 in parallel mode to generate a third drop-out magnetic flux φ_{drop-out} to open the actuator.

Drop-out means 23A, 24 comprise a fourth opening means T4 connected in series with free-wheel diode D2. They comprise a Zener diode Dz reverse-connected in parallel to the terminals of free-wheel diode D2. Fourth opening means T4, preferably a transistor, are arranged to receive orders from control sub-unit 24 so as to place themselves in an open state and disconnect free-wheel diode D2, a counter-voltage then being applied to the terminals of windings L1, L2.

Drop-out means 23A, 24 comprise a fifth opening means T5 connected in series with Zener diode Dz. Fifth opening means T5 are arranged to receive orders from control sub-unit 24 so as to place themselves in a closed state during a drop-out operation, fifth opening means T5 being open during the closing or holding operations of the actuator.

The drop-out means enable windings L1, L2 to switch to parallel mode and facilitate drop-out of the electromagnet by reducing the required counter-voltage level. This results in simplification of the electronic circuitry in particular as far as Asics components which will be able to operate at lower voltages are concerned. Compared with known solutions, for the same holding current value and for the counter-voltage value, switching of the windings to parallel mode thereby enables the actuator to be demagnetized more quickly and therefore to open more quickly. Furthermore, for the same holding current value, for the same demagnetization time, placing the windings in parallel mode enables demagnetization with a lower counter-voltage. For example, the opening speed is obtained with a counter-voltage value that is twice as small.

According to another alternative embodiment of the second preferred embodiment, the third opening means T3 comprise a transistor connected in series with switching diode D1.

According to the embodiments represented in FIGS. 1 and 2, control means 20 comprise voltage measuring means 25 designed to detect the voltage U_{AB} between first and second voltage supply terminals A, B before the closing operation, and to control the voltage supplied to windings L1, L2 according to the supply voltage U_{AB} detected during the closing operation.

According to an alternative embodiment of the preferred embodiments, each winding L1, L2 can comprise a free-wheel diode reverse-connected in parallel to these terminals.

When the control orders sent to the actuator, in particular during holding phase, are transmitted over long distances with electric lines, the presence of stray capacitances on the electric lines may generate a residual voltage at the actuator terminals. This residual voltage can in particular modify the time required for detection of the drop-out voltage. For example purposes, the time required for detection of the drop-out voltage can be increased.

Thus, with actuators with a low electric consumption and in the presence of very large power supply cable lengths, cancelling the supply voltage does not immediately cause opening of the actuator. The stray capacitances are charged and behave like a filter or shield. This problem is unsolvable when the actuator has a low consumption and is supplied with a high voltage.

The detrimental effect of stray capacitances on the opening time of an actuator can be limited by reducing the impedance of the actuator seen from the voltage supply source. Reducing the impedance of the actuator does in fact enable a larger total amount of energy to be absorbed, in particular by absorbing the energy contained in the stray capacitances.

The amount of energy absorbed under these conditions is however limited by the capacity of the actuator to withstand thermal stresses. The energy due to a voltage variation of the supply source in the presence of stray capacitances has to be able to be detected and absorbed without causing an excessive heat rise of the actuator.

According to a particular embodiment of the foregoing modes, control means 20 of the electromagnetic actuator comprise test means cyclically controlling configuration change of said at least two windings L1, L2. During holding phase, the test means send orders to switching means 10 to temporarily place said at least two windings L1, L2 in parallel. The impedance reduction of the actuator then takes place through change of configuration of the windings from series mode to parallel mode. Placing windings L1, L2 in parallel mode has the consequence of reducing the impedance of the actuator by a factor k, factor k being equal to the ratio between the resistance of windings L1, L2 in series mode and the resistance of the windings in parallel mode.

The time constant of electric circuit RLC formed by windings L1, L2 and by stray capacitances is also reduced by a factor k. The voltage drop at the terminals of said capacitances is therefore quicker and the drop-out voltage detection time is thus reduced by a factor k. The speed of the voltage drop can be further increased by increasing the level of the coil regulation setpoint current. In the latter case, we will be limited by a risk of overheating of the actuator. The series-parallel configuration change is preferably performed in cyclic manner. The time taken by this test phase during which the windings are placed in parallel mode has to be integrated in the drop-out voltage detection time.

1. An electromagnetic actuator comprising:
a magnetic circuit formed by a ferromagnetic yoke extending along a longitudinal axis, and a movable ferromagnetic core mounted with axial sliding along the longitudinal axis of the yoke,
at least two windings,
switching means of the windings from a series position to a parallel position and vice-versa,
comprising control means comprising:
regulating means of the electric current flowing in said at least two windings,
inrush means arranged such as to:
control the voltage supplied to said at least two windings during a closing operation of the actuator, and
control the switching means to place said at least two windings in parallel mode to generate a first inrush magnetic flux to close the actuator,
holding means arranged such as to:
control the current supplied to said at least two windings during a holding operation of the actuator in the closed position and,
control the switching means to place said at least two windings in series mode to generate a second holding magnetic flux.

2. The electromagnetic actuator according to claim 1 wherein the regulating means comprise a comparator comparing the value of an electric current flowing in said at least two windings with a setpoint, said comparator being connected to a corrector associated with an amplifier controlling a switch

3. The electromagnetic actuator according to claim 2 wherein the regulating means comprise control means to modulate the voltage supply of said at least two windings in pulse width modulation.

4. The electromagnetic actuator according to claim 1 comprising a first and second winding.

5. The electromagnetic actuator according to claim 4 wherein the switching means comprise:
first opening means connected in series between a first terminal of the first winding and a first voltage supply terminal, a second terminal of the first winding being connected to a second voltage supply terminal via the control transistor,
second opening means connected in series between the second terminal of the first winding and a second terminal of the second winding, said second winding having a first terminal connected to the first voltage supply terminal and the second terminal connected to the second voltage supply terminal via the control transistor,
third opening means directly connected in series between the second terminal of the second winding and the first terminal of the second winding,
at least one free-wheel diode reverse-connected in parallel between the second terminal of the first winding and the first terminal of the second winding,
the three opening means being arranged to receive orders from the inrush or holding means so as to place themselves respectively in an open or closed state;
the windings being in series mode when the first and second opening means are open and the third opening means are closed,
the windings being in parallel mode when the first and second opening means are closed and the third opening means are open.

6. The electromagnetic actuator according to claim 1, wherein the control means comprise measuring means designed to detect the current flowing through the two windings.

7. The electromagnetic actuator according to claim 1, wherein the control means comprise drop-out means arranged such as to:
control a counter-voltage supplied to the two windings,
control the switching means to place the two windings in parallel mode to generate a third drop-out magnetic flux.

8. The electromagnetic actuator according to claim 7, wherein the drop-out means comprise:
fourth opening means connected in series with the free-wheel diode,
a diode Zener reverse-connected in parallel to the terminals of the free-wheel diode,
the fourth opening means being arranged so as to be controlled by the control sub-unit so as to place itself in an open state and to disconnect the free-wheel diode, a counter-voltage being applied to the terminals of the windings.

9. The electromagnetic actuator according to claim 1, wherein the control means comprise voltage measuring means able to:
detect the voltage between the first and second voltage supply terminal before the closing operation, and
control the voltage supplied to the windings according to the supply voltage detected during the closing operation.

10. The electromagnetic actuator according to claim 1, comprising a first and second winding having the same ohmic resistance.

11. The electromagnetic actuator according to claim 10, wherein the windings are identical and comprise the same inductance and the same number of turns.

12. The electromagnetic actuator according to claim 10, wherein the windings are arranged on 2 separate coils.

13. The electromagnetic actuator according to claim 10, wherein the windings are cylindrical and aligned along the same longitudinal axis.

14. The electromagnetic actuator according to claim 1, comprising test means cyclically controlling change of configuration of said at least two windings during holding phase, the test means sending orders to the switching means to temporarily place said at least two windings in parallel.
